(19) United States
(12) Patent Application Publication
(10) Pub. No.: US 2017/0244141 A1
(43) Pub. Date: Aug. 24, 2017

(54) TEMPERATURE DEPENDENT FUSE FOR BATTERY COOLING SYSTEM

(71) Applicant: Faraday&Future Inc., Gardena, CA (US)

(72) Inventor: Phillip John Weicker, Pasadena, CA (US)

(21) Appl. No.: 15/050,269

(22) Filed: Feb. 22, 2016

(51) Int. Cl. H01M 10/637; H01M 2/34; B60L 11/18; H01M 10/625; H01M 10/6567; H01M 10/42; H01M 10/613

(52) U.S. Cl. CPC H01M 10/637; H01M 10/4257; H01M 2/348; H01M 10/613; H01M 10/625; H01M 10/6567; B60L 11/1874; H01M 2220/20

(57) ABSTRACT

Systems and methods for overheating protection in a liquid cooled vehicle battery are disclosed. Systems can include a battery housing enclosing at least one electrochemical cell and a temperature dependent fuse connected in series with the at least one electrochemical cell. A cooling system may circulate liquid coolant through the battery housing. In the event of a cooling system failure, the temperature dependent fuse may blow before the temperature of the at least one electrochemical cell increases enough to damage the battery.

### BACKGROUND

Field

This disclosure relates to battery protection systems and, more specifically, to systems and methods for battery over temperature protection in liquid-cooled battery systems.

Description of the Related Art

Electric vehicles generally use one or more electric motors for propulsion and are powered by a battery system. Such vehicles include road and rail vehicles, surface and underwater vessels, electric aircraft, and electronic recreational devices. Electric vehicles release zero air pollutants and generate less noise than conventional combustion engine vehicles. Currently, lithium-ion batteries are often used. Overheating lithium-ion batteries present a significant fire hazard, necessitating protection systems to stop lithium-ion batteries from charging or discharging when overheated.

### SUMMARY

The systems and methods of this disclosure each have several innovative aspects, no single one of which is solely responsible for its desirable attributes. Without limiting the scope as expressed by the claims that follow, its more prominent features will now be discussed briefly.

In one embodiment, a battery with overheating protection is described. The battery may include a housing enclosing at least one electrochemical cell and a temperature dependent circuit interrupting element connected electrically in series with the at least one electrochemical cell. The temperature dependent circuit interrupting element may have a continuous current capacity that decreases as the temperature of the circuit interrupting element increases. The battery may further include a coolant within the housing, the coolant in thermal contact with at least a portion of the circuit interrupting element.

In another embodiment, an electric vehicle with a battery cooling and protection system is described. The vehicle may include at least one electric motor and a liquid cooled battery for powering the at least one electric motor. The liquid cooled battery may include a battery in thermal contact with a liquid coolant. The vehicle may further include a battery protection system including at least one temperature dependent circuit interrupting element in thermal contact with the liquid coolant. The circuit interrupting element may be arranged in series with the battery, and may have a continuous current capacity that decreases as the temperature of the circuit interrupting element increases.

In another embodiment, a battery protection apparatus is described. The battery protection apparatus may include means for enclosing at least one electrochemical cell and means for interrupting a circuit connected electrically in series with the at least one electrochemical cell. The circuit interrupting means may be configured to interrupt the circuit when a current greater than a continuous current capacity travels through the circuit interrupting means. The circuit interrupting means may have a continuous current capacity that decreases as the temperature of the circuit interrupting means increases. The battery protection apparatus may further include means for cooling the at least one electrochemical cell and the circuit interrupting means.

In another embodiment, a method of battery over-temperature protection comprises immersing one or more electrochemical cells and at least one temperature dependent circuit interrupting element in a common liquid coolant.

### BRIEF DESCRIPTION OF THE DRAWINGS

The above-mentioned aspects, as well as other features, aspects, and advantages of the present technology will now be described in connection with various implementations, with reference to the accompanying drawings. The illustrated implementations are merely examples and are not intended to be limiting. Throughout the drawings, similar symbols typically identify similar components, unless context dictates otherwise.

FIG. 1 is a graph depicting an example temperature dependence of the continuous current capacity of a temperature dependent fuse in accordance with an exemplary embodiment.

FIG. 2 is a block diagram depicting an arrangement and operation of a liquid cooled battery with a temperature dependent fuse in accordance with an exemplary embodiment.

FIG. 3 depicts a configuration of a liquid cooled battery with a temperature dependent fuse in accordance with an exemplary embodiment.

FIG. 4A depicts an example configuration of a liquid cooled battery with a temperature dependent fuse in accordance with an exemplary embodiment.

FIG. 4B depicts an example configuration of a liquid cooled battery with a temperature dependent fuse in accordance with an exemplary embodiment.

FIG. 5 is a simplified diagram depicting a chassis of an electric vehicle incorporating temperature dependent fuses in accordance with an exemplary embodiment.

FIG. 6 is a simplified diagram depicting multiple battery strings within an electric vehicle in accordance with an exemplary embodiment.

### DETAILED DESCRIPTION OF THE PREFERRED EMBODIMENT

The following description is directed to certain implementations for the purpose of describing the innovative aspects of this disclosure. However, a person having ordinary skill in the art will readily recognize that the teachings herein can be applied in a multitude of different ways. The described implementations may be implemented in any electrical circuit. In some implementations, the word “battery” or “batteries” will be used to describe certain elements of the embodiments described herein. It is noted that “battery” does not necessarily refer to only a single battery cell. Rather, any element described as a “battery” or illustrated in the Figures as a single battery cell in a circuit may equally be made up of any larger number of individual battery cells and/or other elements, or may be a single module within a larger battery structure, without departing from the spirit or scope of the disclosed systems and methods.

One or more batteries may use a liquid coolant to maintain appropriate operating temperatures. For example, one or more batteries may be enclosed by a housing and surrounded by liquid coolant. In some embodiments, coolant or cooling liquid or cooling fluid may include, for example, one or more of the following: synthetic oil, polyolefin (e.g., poly-alpha-olefin (“PAO”)), ethylene glycol, ethylene glycol and water, and phase change materials (“PCM”). In some aspects, battery cooling systems employ liquid dielectrics as the coolant. The coolant may be configured to transfer heat from the liquid coolant to the housing. The housing may include one or more heat sinks. In some embodiments, liquid may be circulated through the housing and/or through a heat exchanger.

Liquid cooled battery systems may experience undesirable temperature fluctuations if the coolant becomes too warm during operating conditions due to, for example, a heat exchange failure, a battery malfunction, or if the coolant leaks, evaporates, or otherwise exits the battery cooling system. In the latter case, the coolant temperature may rise because there is not enough total coolant in the system to provide enough total cooling. Loss or excessive heating of coolant may result in possible battery damage, fire, or other harm.

Detecting loss or excessive heating of coolant is challenging. A battery may be disconnected if the battery or its surrounding coolant is measured to be above a determined temperature threshold. Detecting the loss of coolant using conventional float sensors is ineffective because liquid dielectrics ordinarily experience significant thermal expansion and contraction due to the temperature fluctuations of normal battery operation. Other heat sensors may be prone to failure. Digital heat sensors may need electrical power in order to operate. Other computer aided heat sensing may be susceptible to failure or malfunction.

To reduce or eliminate these problems, and/or to provide an additional level of protection in addition to the above described systems and methods, a temperature dependent fuse may be used to disconnect a liquid cooled battery in the event of the loss of coolant or any other reason for excessive heating of the coolant such as battery overload or malfunction. Ordinary fuses are formed as resistive metallic links that get hotter as current increases, due to resistive heating. When the resistor melts or vaporizes, current can no longer flow through the fuse. When the resistor melts and/or vaporizes, the fuse is “tripped” or “blown.” Such fuses exhibit temperature dependent blowing characteristics because when the ambient temperature surrounding the fuse material increases, the amount of current needed to melt or vaporize the resistor may decrease.

To define this feature of such fuses, the term “continuous current capacity” is used herein, which is intended to mean the current which a fuse will carry indefinitely without blowing and without significant thermal stress related degradation in material properties over the intended useful life of the fuse. Currents through a fuse of larger than the continuous current capacity of the fuse will blow the fuse and interrupt the circuit. Currents only slightly above the continuous current capacity of a fuse might take hours or more to blow the fuse, and currents that greatly exceed the continuous current carrying capacity of the fuse might blow the fuse in a fraction of a second. The continuous current capacity as used herein is generally related to a nominal “rating” of a fuse as assigned by fuse manufacturers to their products, but may be somewhat lower. For example, many fuse manufacturers recommend that the continuous current a fuse will carry in use be only 70-80% of the nominal fuse rating. In temperature dependent fuses, the continuous current capacity will decrease as the ambient temperature in which the fuse operates increases.

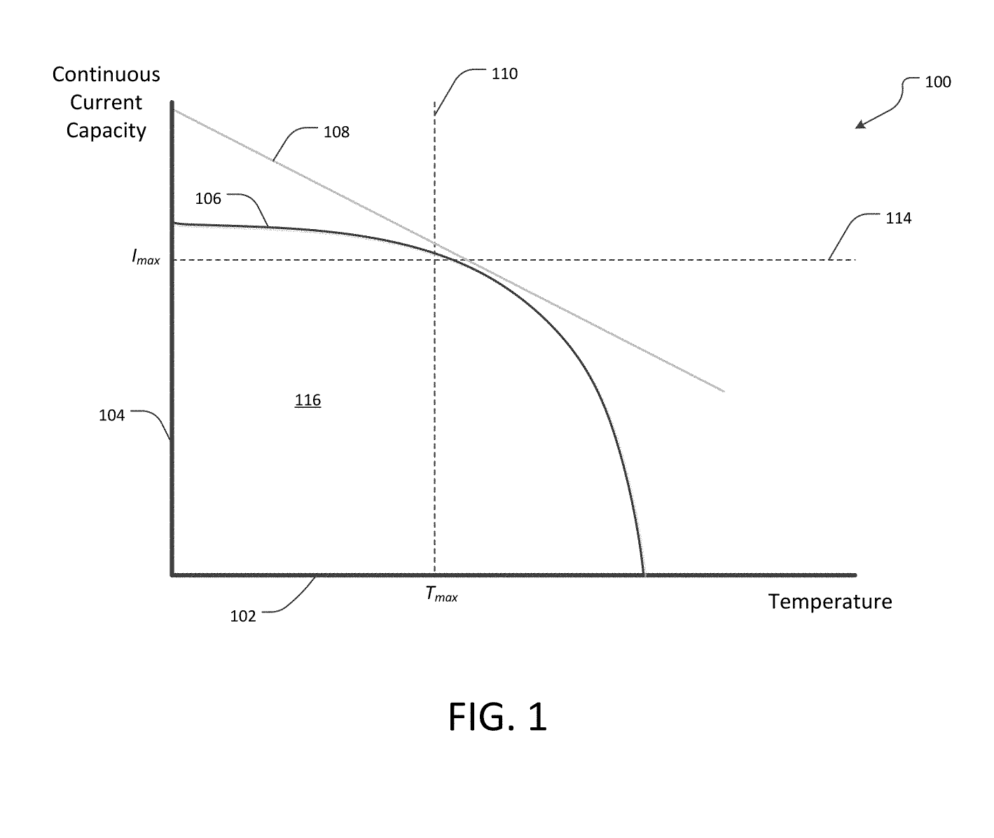

FIG. 1 is a graph 100 depicting an example temperature dependence of the continuous current capacity of a temperature dependent fuse in accordance with an exemplary embodiment. The x-axis 102 represents the ambient temperature of the fuse surroundings, while the y-axis 104 represents the continuous current capacity. Lines 106 and 108 represent possible temperature dependence profiles for the continuous current capacity of example temperature dependent fuses.

A battery system may be designed to operate within a normal temperature range, below a maximum temperature 110, labeled Tₘₐₓ in the graph 100. In some embodiments, it may be allowable to operate a battery system at temperatures exceeding Tₘₐₓ 110, although battery damage or failure may occur at higher temperatures or if exposed to excessive temperatures for an extended time. A battery system may additionally have a maximum current Iₘₐₓ 114, which is the maximum current to be drawn from the battery under normal operating conditions. Currents greater than Iₘₐₓ 114 may also create a risk of battery damage or failure by overheating or otherwise. If the battery is an electric vehicle propulsion battery, Iₘₐₓ 114 may be relatively large, for example, as large as 300 A-500 A or greater.

A temperature dependent fuse for use in this application would preferably be designed not to trip when temperature and current are normal 116. When temperature exceeds Tₘₐₓ 110, the fuse would preferably trip at currents of less than Iₘₐₓ 114. Thus, a temperature dependent fuse may exhibit a variable continuous current capacity similar to profile 106, with a continuous current capacity that remains higher than Iₘₐₓ 114 for all temperatures below Tₘₐₓ 110, but drops off when the fuse temperature exceeds Tₘₐₓ 110. In some embodiments, material properties may result in a temperature dependent fuse with a more linear temperature dependence similar to profile 108. A linear temperature dependence 108 may be acceptable as well, as long as the continuous current capacity at temperatures above Tₘₐₓ 110 drops off enough to allow the fuse to blow at currents less than Iₘₐₓ 114.

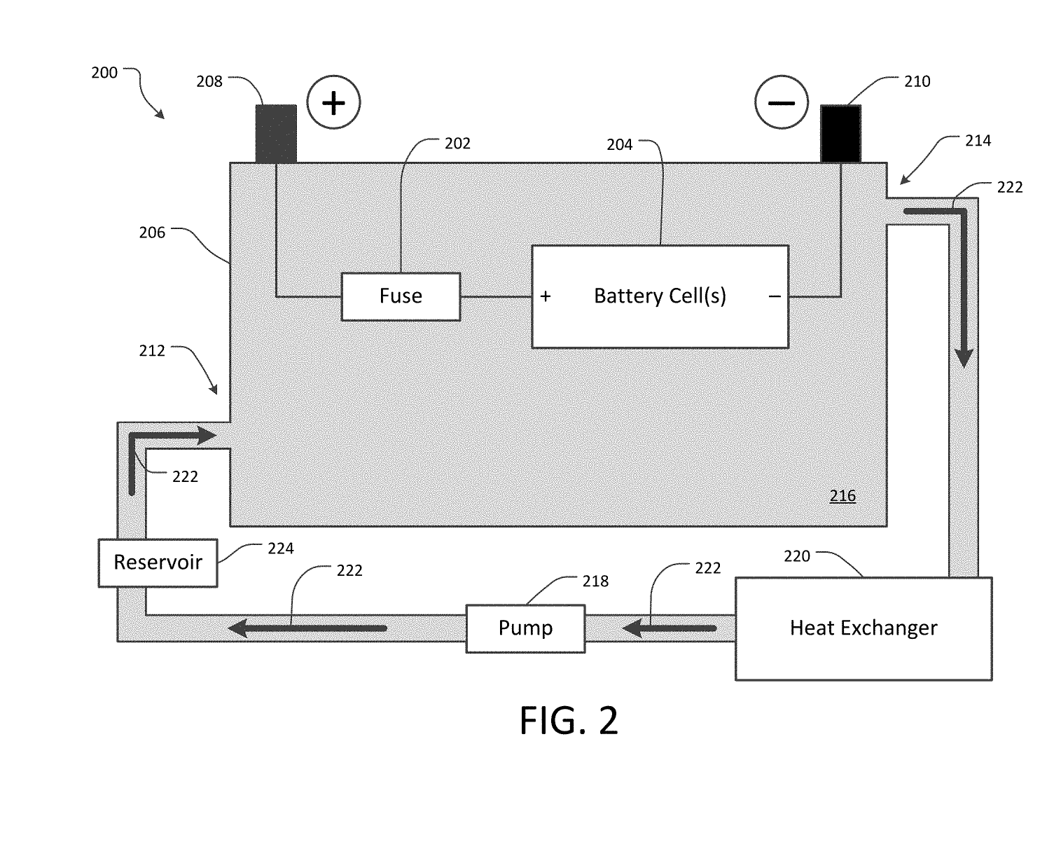

FIG. 2 is a block diagram depicting an arrangement and operation of a liquid cooled battery 200 with a temperature dependent fuse 202 in accordance with an exemplary embodiment. A battery 200 may include one or more electrochemical cells 204 disposed within a housing 206. The one or more electrochemical cells 204 may be connected electrically with battery terminals 208 and 210, where connections may be made to power vehicle systems, such as lights, powertrain, climate control, braking assist, or any other vehicle system capable of using electrical power. The positive terminal 208 of the battery 200 may be connected to the positive terminal, or cathode, of the one or more electrochemical cells 204, while the negative terminal 210 of the battery 200 may be connected to the negative terminal, or anode, of the one or more electrochemical cells 204.

The temperature dependent fuse 202 may be connected electrically in series with the one or more electrochemical cells 204. In some embodiments, the temperature dependent fuse 202 may be connected between the cathode of the one or more electrochemical cells 204 and the positive terminal 208 of the battery 200, or between the anode of the one or more electrochemical cells 204 and the negative terminal 210 of the battery 200. In embodiments including a plurality of electrochemical cells, the temperature dependent fuse 202 may be connected between two or more of the electrochemical cells 204.

A battery 200 may further include a coolant intake 212 and a coolant exit 214. An external cooling system may introduce coolant liquid into the space 216 inside the housing 206 through the coolant intake 212. Coolant entering the space 216 may come from an external coolant reservoir 224. Coolant entering the space 216 may circulate within the space 216, collecting thermal energy created by the operation of cells 204 as it passes. Eventually, the coolant may be drawn out of the space 216 through the coolant exit 214 based on a negative pressure at the coolant exit 214 created by a pump 218 of the cooling system. After exiting the space 216 through the coolant exit 214, liquid coolant may travel to a heat exchanger 220 of the cooling system, and may be returned by the pump 218 to the coolant reservoir 224, and the cooling process may repeat indefinitely.

A lack of coolant due to a leak, failure of the heat exchanger 220, and/or failure of the pump 218 may disrupt the desired flow 222 and/or temperature of coolant in the space 216 within the battery housing 206 and cooling system. Because electrochemical cells 204 tend to produce heat during operation, a disruption in the flow 222 or cooling of the coolant liquid may cause a significant amount of thermal energy to accumulate within the cells 204 and/or the coolant within space 216 if the cells 204 continue to charge or discharge. Excess accumulation of thermal energy may cause cells 204 to reach temperatures much higher than their intended operational temperatures, which may cause battery failure. If cells 204 are lithium-ion or similar, overheating may cause cells 204 to explode or catch fire, causing serious damage or injury. Thus, if the cooling system fails or coolant is lost, excess heating should be avoided by breaking the battery circuit to stop current flow.

The battery circuit may be broken in an active manner by electronically monitoring a coolant level sensor in the reservoir 224 and sending a signal to disengage a magnetic contactor to disconnect the battery. However, a loss of coolant quantity may be difficult to directly detect because coolant liquids may expand or contract significantly due to temperature fluctuation during ordinary operation. Thus, it may be difficult to determine the difference between a coolant loss and ordinary contraction of coolant liquid, resulting in false coolant loss indications or failure to break the circuit in an actual coolant loss event. In some embodiments described herein, a temperature dependent circuit interrupting element such as a temperature dependent fuse 202 may be included to automatically open the battery circuit and stop current flow when the cooling system is unable to adequately cool the cells 204. In some embodiments, such a circuit interrupting element may include a fuse, fusible link, other fusible elements, a contactor, thermal cutoff, spring, bimetallic strip, or the like. In these embodiments, the temperature dependent circuit interrupting element is a “passive” device, meaning it does not rely on any external sensing or signals for operation. Rather, inherent material properties of the device itself determine the conditions under which temperature dependent circuit interrupting element opens the circuit and cause the circuit interruption itself.

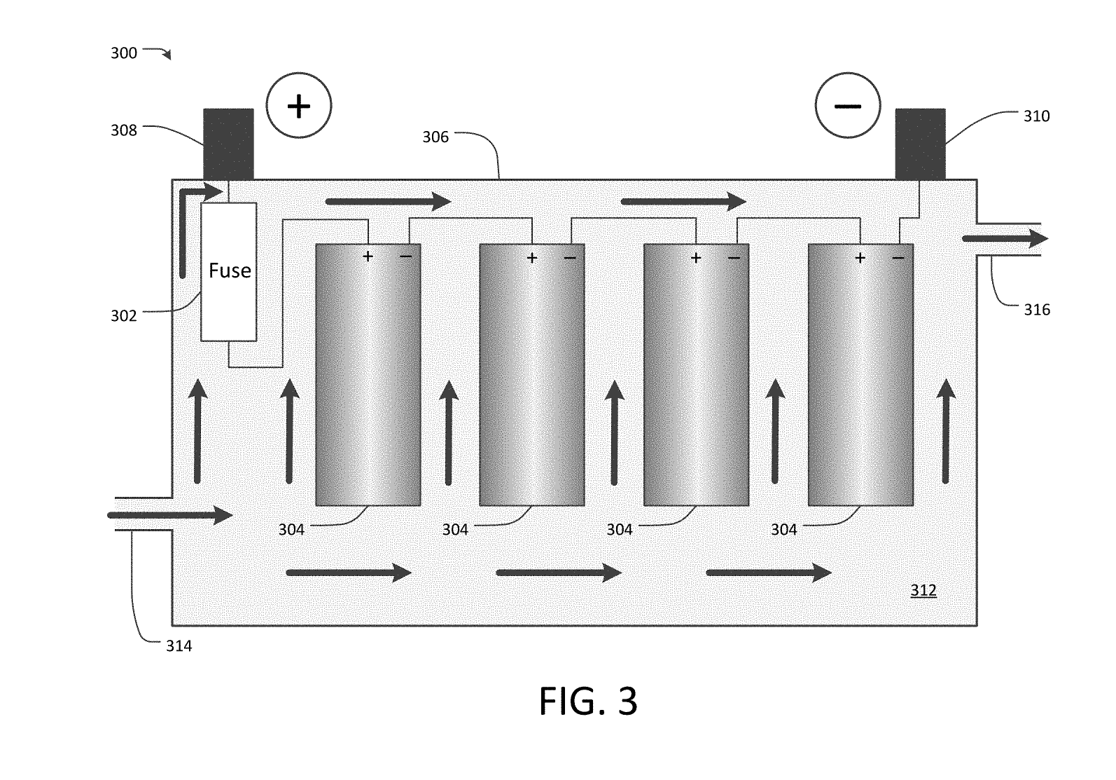

FIG. 3 depicts a configuration of a liquid cooled battery 300 with a temperature dependent fuse 302 in accordance with an exemplary embodiment. A liquid cooled battery 300 may include a plurality of electrochemical cells 304 disposed within a battery housing 306. In some embodiments, electrochemical cells 304 may be connected in series, in parallel, or in a combination of series and parallel connections. Although the configuration of FIG. 3 depicts four cells 304 connected in series, the systems and processes described herein may readily be applied to more complex arrangements of cells 304. For example, a battery 300 may include a plurality of serially connected sets or strings of parallel cells 304, rather than serially connected individual cells 304, so as to provide additional energy storage capacity without increasing the battery voltage. The temperature dependent fuse 302 may be located within the battery housing 306 and connected electrically between at least one electrochemical cell 304 and either the positive terminal 308 or the negative terminal 310 of the battery 300. The fuse 302 should preferably be connected in series with cell or group of cells 304 such that a disconnection at the site of the fuse 302 opens the entire electrical circuit through the battery 300, thus stopping current from flowing between any of the cells 304.

The temperature dependent fuse 302 may be located in the space 312 within the battery housing 306 so that coolant liquid within the space 312 may circulate around both the electrochemical cells 304 and the temperature dependent fuse 302. Similar to the configuration described with reference to FIG. 2 above, liquid coolant may enter the space 312 at a coolant intake 314 and leave the space 312 at a coolant exit 316. Coolant may flow freely throughout the space 312, passing around and between the fuse 302 and the plurality of electrochemical cells 304 before leaving at coolant exit 316, as indicated by bold arrows in FIG. 3.

In some embodiments, the battery 300 and fuse 302 may be configured to operate passively so that protection occurs without electronic detection of a fault in the quantity or temperature of coolant liquid or electronic initiation of a fuse blowing sequence. Passive overheat protection may be triggered if coolant liquid leaks out of the cooling system or becomes too hot to effectively cool the fuse 302. For example, coolant liquid may leak due to a breach in the battery housing 306 from internal or external damage, manufacturing defect, damage to a different part of the cooling system, or any other circumstance that reduces the ability of the cooling system to contain the coolant liquid. Coolant liquid may become too hot to effectively cool the fuse 302, for example, due to a malfunction of the cooling system or excessive heat in within the battery 300, such as a battery overcurrent situation or other battery damage or malfunction.

When coolant liquid is lost or becomes too hot, the temperature of the fuse 302 increases due to the increasing ambient temperature. While some resistive heating of the fuse 302 occurs during ordinary battery operation, the coolant liquid transfers some of this heat away from the fuse 302 so long as the coolant liquid is present and its temperature is low enough. In the absence of sufficient coolant liquid and/or the presence of coolant liquid at too high a temperature, more of the thermal energy released by resistive heating within the fuse 302 remains within the metal of the fuse 302. Thus, the temperature of the fuse 302 may begin to increase when coolant liquid leaves the system or becomes too hot to adequately cool the fuse.

The fuse 302 may be temperature dependent, with a continuous current capacity that decreases as the temperature of the fuse 302 increases. In some embodiments, the fuse 302 may be any kind of fusible element, such as a resistor, fuse, fusible link, thermistor, thermal fuse, thermal cutoff or the like. In some embodiments, the fuse may be composed of a metal or alloy with a relatively low melting point, such that the fuse will melt under relatively low current in the absence of an effective cooling system.

When the continuous current capacity of the fuse 302 decreases below the actual current in the fuse 302, the fuse may blow. Generally, when the current flowing through a fuse is greater than the continuous current capacity of the fuse, the metal of the fuse may melt or vaporize, either immediately or after a time delay. Such melting or vaporizing may break the electrical connection between the two ends of the fuse, opening the circuit in which the fuse is located. Accordingly, current stops flowing from the battery 300 when the temperature dependent battery fuse 302 blows, so long as the fuse 302 is connected in series with the plurality of electrochemical cells 304. Thus, the cells 304 will be prevented from continuing to charge or discharge, preventing any damage to the battery 300 from potential overheating.

In some embodiments, the location of the fuse 302 within the battery housing 306 may be selected to enhance the effectiveness of passive overheat protection. For example, the fuse 302 may be located in an upper portion of the battery housing 306. In another example, the fuse 302 may be located near the coolant intake 314. It may be more practical in some embodiments to locate the fuse 302 near the middle of the housing 306 or near the coolant exit 316, depending on the particular temperature dependence of the fuse material.

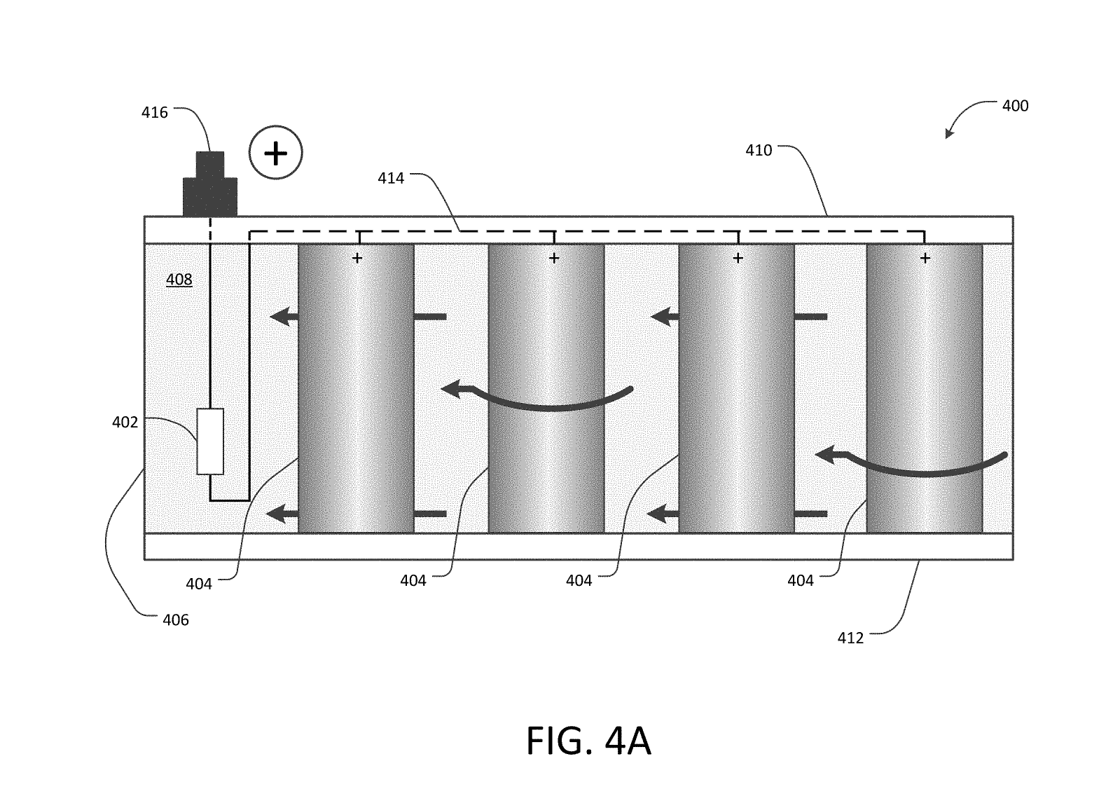

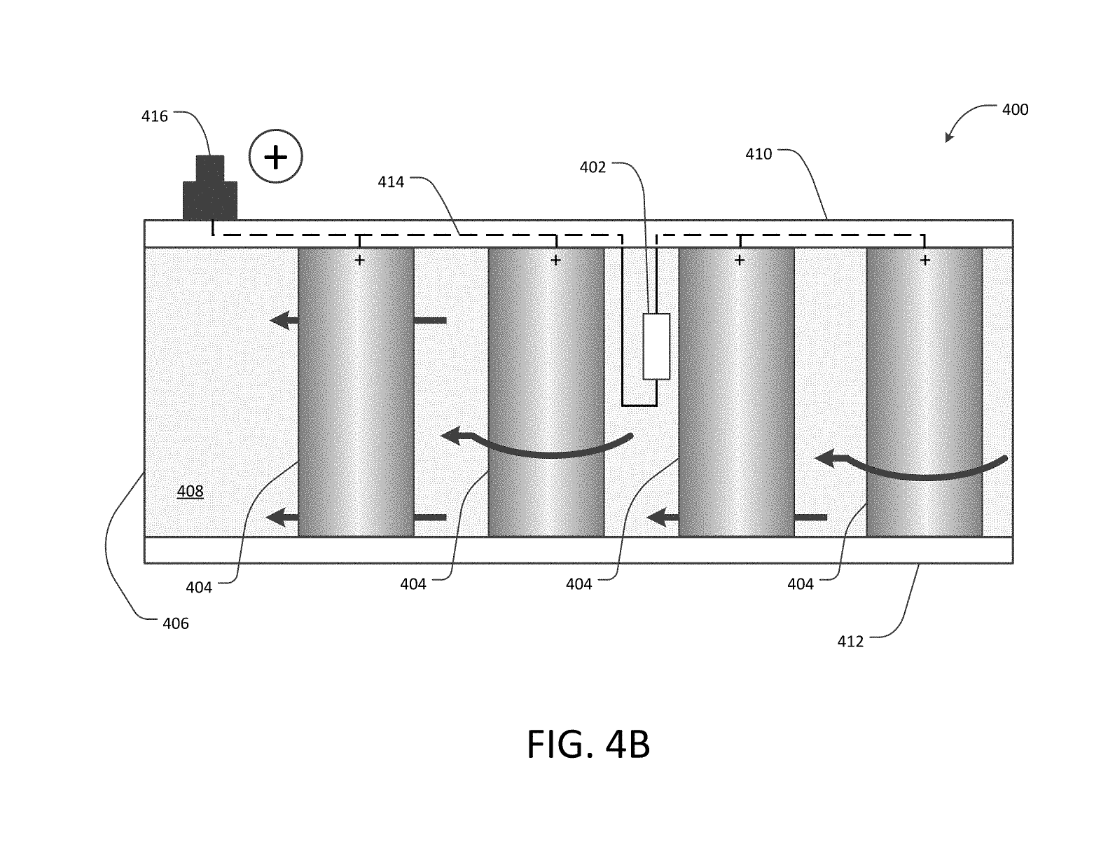

FIGS. 4A and 4B depict example configurations of a liquid cooled battery 400 with a temperature dependent fuse 402 in accordance with exemplary embodiments. As in FIGS. 2 and 3, the configurations in FIGS. 4A and 4B include electrochemical cells 404 enclosed within a battery housing 406, with bold arrows indicating the flow of coolant liquid through the space 408 within the housing 406. The configuration of FIG. 4A includes a fuse 402 connected in series between the positive terminal 416 of the battery 400 and the cells 404. The configuration of FIG. 4B includes an alternative arrangement, wherein the fuse 402 is connected near the middle of the battery 400, connected electrically between two of the cells 404. The fuse 402 may be in various locations throughout the interior of the battery 400, so long as the fuse 402 is connected in series with the cells 404 such that there is no alternative current path through the battery that would allow the cells 404 to charge or discharge even after the fuse 402 has blown.

In some embodiments, electrochemical cells 404 may be held in place by one or more support structures. For example, cells 404 may be held in place by upper and lower end plates 410 and 412. In some embodiments, upper end plate 410 and/or lower end plate 412 may include cutaway or indented portions sized and shaped to accommodate the circular end of a cell 404. In some aspects, an upper end plate may also support, include, and/or anchor circuitry 414, such as a flex circuit, printed circuit, or internal wiring, for carrying current to and/or from cells 404. FIGS. 4A and 4B depict the circuitry 412 connecting the cathodes of the cells 404 to the positive terminal 416 of the battery 400. Circuitry connecting the anodes of the cells 404 to a negative terminal of the battery 400 is not shown but would also be present. In various embodiments, the negative circuitry may be included in the opposite end plate 412, or within the same end plate 410, depending on the location of anode and cathode on the cells 404. In embodiments wherein positive circuitry 414 is contained within a flex circuit, the negative circuitry may be contained within a second conductive layer of the flex circuit, separated from the positive conductive layer by an electrically insulating material.

In a liquid cooled battery 400, holding cells 404 in place by securing at the upper and lower ends of the cells 404 with end plates 410 and 412 may offer the advantage of creating a space 408 within the battery 400 for a coolant liquid to flow freely and contact the outer surfaces of the cells 404. In some embodiments, cells 404 may be disposed in a separated configuration such that the exterior surface of each cell 404 is not in contact with the exterior surface of any other adjacent cell 404. A separated configuration may provide the advantage of allowing coolant liquid to contact all surfaces of cells 404 as it circulates within space 408. Securing the cells 404 with end plates 410 and 412 may provide further advantages of adding structural integrity and resistance to damage caused by vibration of cells 404.

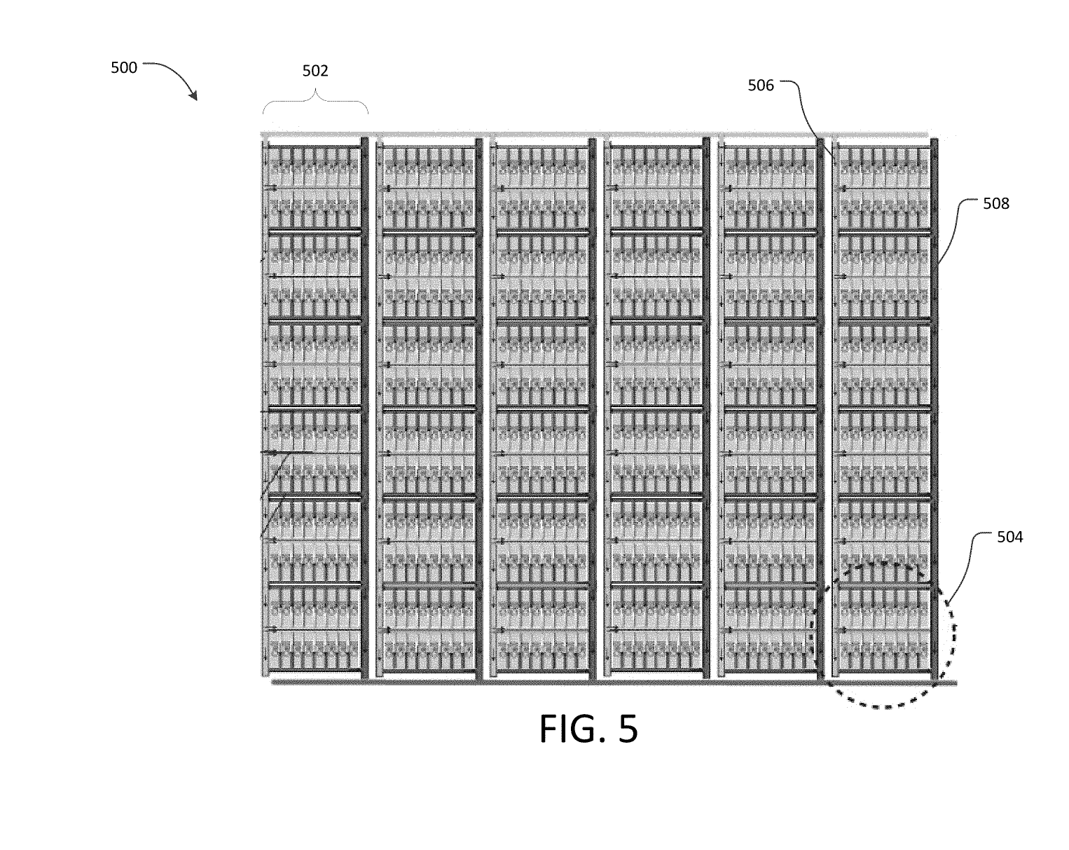

FIG. 5 is a diagram depicting multiple battery strings 502 within an electric vehicle battery pack 500 in accordance with an exemplary embodiment. In some embodiments, multiple batteries may be packaged in a module 504, with multiple modules 504 combined to form a battery pack 500. The individual batteries or battery modules 504 may be arranged in strings 502. A battery or battery module 504 may include one or more electrochemical cells. For example, each battery module 504 may comprise one or more batteries as described and depicted above with reference to FIGS. 2-4B. The batteries may comprise any type of battery suitable for electric vehicle propulsion, such as lithium-ion batteries, nickel metal hydride batteries, lead acid batteries, or the like. In some embodiments, battery pack 500 may be a high voltage battery pack configured to power an electric vehicle powertrain. In some embodiments, battery pack 500 may be a low voltage (e.g., 12V) battery pack configured to power various electric vehicle systems.

A battery string 502 may be formed by connecting two or more battery modules 504 in series. Multiple strings 502 may be combined in parallel to create larger battery pack 500. Connecting multiple strings 502 in parallel allows for additional energy storage without increasing the voltage of the battery pack 500. For example, the battery pack 500 depicted in FIG. 5 may comprise six strings 502 of identical voltage and energy storage capacity, so that the energy storage capacity of the entire battery pack 500 is equal to six times the storage capacity of an individual string 502, while the voltage of the entire battery pack 500 is equal to the voltage of each individual string 502. The use of battery strings 502 allows for the addition of more strings 502 to add extra energy storage capacity to the battery pack 500 without affecting the voltage produced.

In embodiments combining multiple battery modules 504, liquid cooling may be performed in the same manner as described above with reference to FIGS. 2-4B. In some embodiments, a single cooling system, including a coolant reservoir, pump, and heat exchanger, may be used to provide chilled coolant to multiple battery modules 504, multiple strings 502, or even an entire battery pack 500. Conduits 506 and 508 may be provided throughout the battery pack 500 to transport coolant between battery modules 504, strings 502, and the cooling system. In some embodiments, an intake conduit 506 may deliver chilled coolant from the cooling system to the battery modules 504, and a return conduit 508 may collect and return warmed coolant from the battery modules 504 to the cooling system.

Temperature dependent fuses may be employed with a multi-battery pack 500 in the same manner as described above with reference to FIGS. 1-4B. In some embodiments, a single fuse may be used for multiple battery modules 504. For example, where multiple batteries 504 are arranged in series in parallel strings 502, one fuse may be used for each string 502, rather than including a separate fuse for each battery module 504.

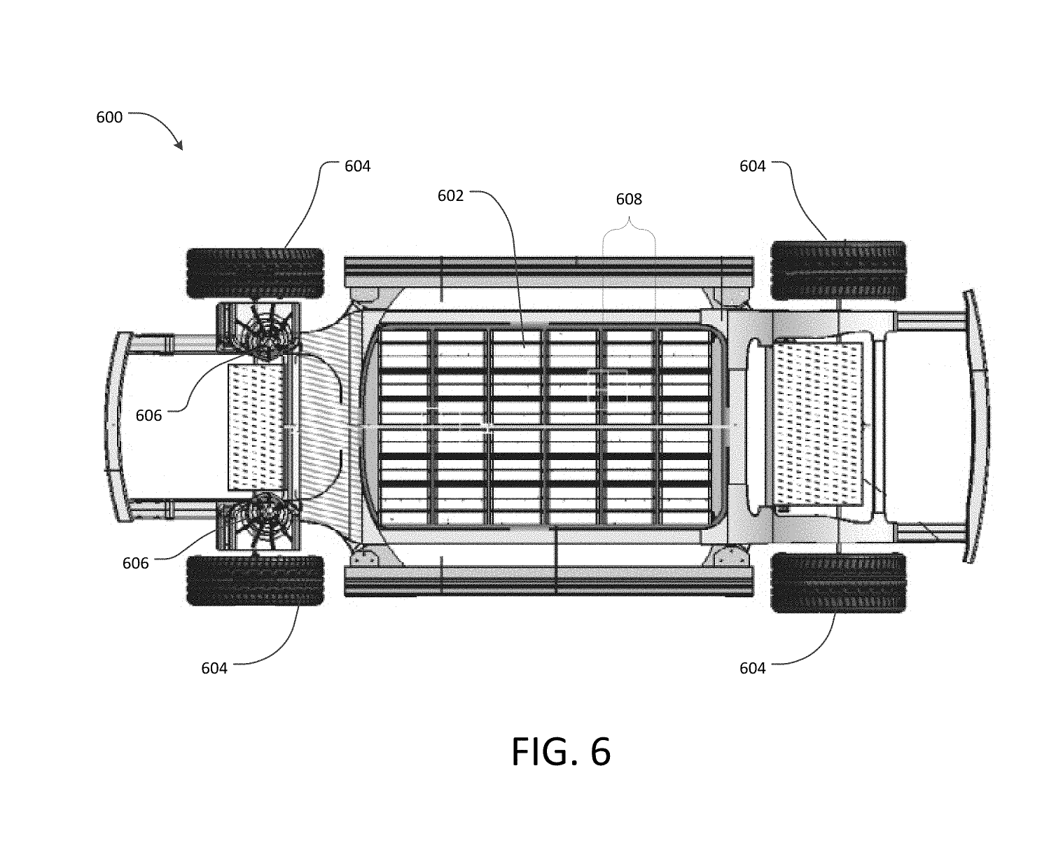

FIG. 6 is a diagram depicting a chassis of an electric vehicle 600 incorporating temperature dependent fuses in accordance with an exemplary embodiment. An electric vehicle 600 may include a powertrain comprising a battery pack 602, a plurality of wheels 604 and at least one electric traction motor 606 configured to turn the wheels 604 and propel the vehicle 600. The battery pack 602 may be configured to provide electric power to the traction motors 606. In some embodiments, the battery pack 602 may include multiple battery strings 608. Strings 608 may be individually switchable so that some strings 608 may be active and provide power while other strings 608 are disconnected from the rest of the vehicle. Individually switchable strings may improve performance and reliability, for example, by allowing the vehicle 600 to continue driving after a failure or fault detection in one or more strings 608, as the faulty string(s) may be disconnected while the remaining strings continue providing power.

Temperature dependent fuses as described above with reference to FIGS. 1-5 may provide a similar benefit if used in each battery string 608. If a cooling system failure occurs in any of the strings 608, a temperature dependent fuse in that string may trip as described above. When a fuse in one string 608 trips, the effect is similar to that of disconnecting the entire string from the battery pack 602 circuit. When the fuse in a string 608 trips, current stops flowing through that string 608, and the string 608 may be protected from any further damage from overheating.

Additional details and embodiments relating to the use of liquid cooled batteries in electric vehicles are described in U.S. application Ser. No. 14/841,617, titled “Vehicle Energy-Storage System” and filed on Aug. 31, 2015, which is incorporated by reference herein in its entirety.

The foregoing description details certain embodiments of the systems, devices, and methods disclosed herein. It will be appreciated, however, that no matter how detailed the foregoing appears in text, the devices and methods can be practiced in many ways. As is also stated above, it should be noted that the use of particular terminology when describing certain features or aspects of the invention should not be taken to imply that the terminology is being re-defined herein to be restricted to including any specific characteristics of the features or aspects of the technology with which that terminology is associated. The scope of the disclosure should therefore be construed in accordance with the appended claims and any equivalents thereof.

With respect to the use of any plural and/or singular terms herein, those having skill in the art can translate from the plural to the singular and/or from the singular to the plural as is appropriate to the context and/or application. The various singular/plural permutations may be expressly set forth herein for sake of clarity.

It is noted that the examples may be described as a process. Although the operations may be described as a sequential process, many of the operations can be performed in parallel, or concurrently, and the process can be repeated. In addition, the order of the operations may be rearranged. A process is terminated when its operations are completed. A process may correspond to a method, a function, a procedure, a subroutine, a subprogram, etc.

The previous description of the disclosed implementations is provided to enable any person skilled in the art to make or use the present disclosed process and system. Various modifications to these implementations will be readily apparent to those skilled in the art, and the generic principles defined herein may be applied to other implementations without departing from the spirit or scope of the disclosed process and system. Thus, the present disclosed process and system is not intended to be limited to the implementations shown herein but is to be accorded the widest scope consistent with the principles and novel features disclosed herein.

What is claimed is:

1. A battery protection system comprising:
a housing enclosing at least one electrochemical cell and a temperature dependent circuit interrupting element connected electrically in series with the at least one electrochemical cell; the temperature dependent circuit interrupting element having a continuous current capacity that decreases as the temperature of the circuit interrupting element increases, and
a coolant within the housing, the coolant in thermal contact with at least a portion of the temperature dependent circuit interrupting element.

2. The battery protection system of claim 1, wherein the circuit interrupting element is immersed in the coolant.

3. The battery protection system of claim 1, wherein the housing encloses a plurality of electrochemical cells connected electrically in series.

4. The battery protection system of claim 1, wherein the housing encloses a plurality of electrochemical cells connected electrically in parallel.

5. The battery protection system of claim 1, further comprising a pump and a heat exchanger in fluid communication with the housing.

6. The battery protection system of claim 1, wherein the temperature dependent circuit interrupting element comprises a resistive metal.

7. The battery protection system of claim 1, wherein the temperature dependent circuit interrupting element is configured to open without requiring a temperature measurement.

8. An electric vehicle with a battery cooling and protection system, the vehicle comprising:
at least one electric motor;
a liquid cooled battery system for powering the at least one electric motor, the liquid cooled battery system comprising a battery in thermal contact with a liquid coolant; and
a battery protection system comprising at least one temperature dependent circuit interrupting element in thermal contact with the liquid coolant, the circuit interrupting element arranged in series with the battery and having a continuous current capacity that decreases as the temperature of the circuit interrupting element increases.

9. The electric vehicle of claim 8, wherein at least a portion of the circuit interrupting element is disposed within the liquid coolant.

10. The electric vehicle of claim 8, wherein the liquid cooled battery system contains a first amount of liquid coolant having a first temperature during operation of the electric vehicle.

11. The electric vehicle of claim 10, wherein the liquid cooled battery system is configured such that when the liquid cooled battery system contains a second amount of liquid coolant that is less than the first amount of liquid coolant, the temperature of the second amount of liquid coolant increases to a second temperature that is greater than the first temperature.

12. The electric vehicle of claim 8, further comprising a battery housing, wherein the battery and the temperature dependent circuit interrupting element are enclosed within the housing and wherein at least a portion of the liquid coolant is configured to flow through the housing.

13. The electric vehicle of claim 8, wherein the battery comprises at least one string of battery modules connected in series.

14. The electric vehicle of claim 13, wherein the liquid cooled battery system is configured to move liquid coolant through the at least one string.

15. The electric vehicle of claim 13, wherein the battery comprises a plurality of strings, each string having at least one temperature dependent passive circuit interrupting element.

16. The electric vehicle of claim 8, wherein the temperature dependent circuit interrupting element comprises a resistive metal.

17. The electric vehicle of claim 8, wherein the circuit interrupting element is configured to open without requiring a temperature measurement.

18. A battery protection apparatus comprising:
means for enclosing at least one electrochemical cell;
means for interrupting a circuit connected electrically in series with the at least one electrochemical cell, the circuit interrupting means configured to interrupt the circuit when a current greater than a continuous current capacity travels through the circuit interrupting means; wherein the circuit interrupting means has a continuous current capacity that decreases as the temperature of the circuit interrupting means increases; and
means for cooling the at least one electrochemical cell and the circuit interrupting means.

19. The battery protection apparatus of claim 18, wherein the circuit interrupting means is selected from the group consisting of a fuse, a fusible link, a resistor, a thermistor, a thermal fuse, and a thermal cutoff.

20. The battery protection apparatus of claim 18, wherein the circuit interrupting means is configured to open without requiring a temperature measurement.

21. A method of battery over-temperature protection comprising immersing one or more electrochemical cells and at least one temperature dependent circuit interrupting element in a common liquid coolant.

22. The method of claim 21, comprising enclosing the one or more electrochemical cells in a common housing.

23. The method of claim 22, comprising circulating the common liquid coolant through the common housing.

24. The method of claim 21, wherein the at least one temperature dependent circuit interrupting element is a metallic fuse.
